(19) United States
(12) Patent Application Publication
(10) Pub. No.: US 2014/0344931 A1
(43) Pub. Date: Nov. 20, 2014

(54) SYSTEMS AND METHODS FOR EXTRACTING CRYPTOGRAPHIC KEYS FROM MALWARE

(71) Applicant: Arbor Networks, Inc., Burlington, MA (US)

(72) Inventors: Jeffrey Edwards, Grass Lake, MI (US); Jose O. Nazario, Ann Arbor, MI (US)

(73) Assignee: ARBOR NETWORKS, INC., Burlington, MA (US)

(21) Appl. No.: 14/107,544

(22) Filed: Dec. 16, 2013

Related U.S. Application Data
(60) Provisional application No. 61/824,768, filed on May 17, 2013.

(51) Int. Cl. G06F 21/56

(52) U.S. Cl. CPC G06F 21/562
USPC 726/23

(57) ABSTRACT

A method and system for extracting cryptographic data from a data transmission. A sample of a first data transmission is received over a network. The sample is classified as belonging to a malware family. An extraction engine is selected corresponding to the malware family. The extraction engine is utilized to extract cryptographic data from the sample.

### CROSS-REFERENCE TO RELATED APPLICATIONS

The present application claims priority from U.S. Provisional Patent Application No. 61/824,768, filed May 17, 2013, the contents of each of which are incorporated herein by reference.

### FIELD OF THE INVENTION

The present invention relates to communication networks, and more specifically, to techniques for decrypting malware samples.

### BACKGROUND OF THE INVENTION

Malware, which is short for “malicious software”, is a general description of a broad class of software that malicious entities (e.g. hackers) utilize for a variety of purposes, such as disrupting computer networks, gaining unauthorized access to systems, and stealing information. Examples of malware include, but are not limited to, computer viruses, spyware, trojan horses, and botnets. In order to provide for efficient, error free, and secure operations of networks and systems, individuals and entities (e.g. governments and corporations) rely on anti-malware technology to prevent and mitigate the damage of malware attacks.

One example of anti-malware technology are systems (e.g. hardware and/or software) that is used to counter malicious botnets. A malicious botnet is a type of malware that is used to gain control over a number of computers (referred to as “bots”). A botnet controller uses a server called a command and control (C&C) server to communicate with the bots to command them to engage in malicious activities. For example, a botnet controller may use a number of bots to cause a distributed denial of service (DDoS) attack, which attempts to render a machine or network resource unavailable by flooding the resource with illegitimate communications, such as fraudulent requests for resources. Anti-malware systems counter DDoS attacks by identifying, analyzing, and blocking network traffic that originates from malicious botnets and removes the malicious traffic before such traffic reaches its intended destination.

One way to identify malicious traffic is to capture and analyze the binary malware samples and communications between individual bots and their command and control (C&C) servers. Such communications can be captured through sensors, honeypots, and/or spam traps. Once captured, these communications can be analyzed to determine valuable information about the botnet, such as a C&C server, the target, and motives of the entity behind the botnet. Such information can then be used to prevent attacks or to prevent the malicious traffic from reaching its source.

It has become more difficult, however, to identify and monitor communications between C&C servers and bots because there is an increasing trend by which encryption is used to protect the communications between C&C servers and bots. Such encryption can be defeated if a security researcher has access to the cryptographic key and method by which the communication is encrypted. Accordingly, what is needed are systems and methods for automatically extracting cryptographic keys from malware.

### SUMMARY OF THE INVENTION

The purpose and advantages of the invention will be set forth in and apparent from the description that follows. Additional advantages of the invention will be realized and attained by the devices, systems and methods particularly pointed out in the written description and claims hereof, as well as from the appended drawings.

To achieve these and other advantages, and in accordance with the purposes of the below illustrated embodiments, in one aspect, a system and method for extracting cryptographic data from a data transmission is provided. A sample of the data transmission is obtained and analyzed statically and/or dynamically. The sample is classified as belonging to a malware family based on this analysis. An extraction engine is selected corresponding to the malware family. The extraction engine is utilized to extract cryptographic data from the sample.

### BRIEF DESCRIPTION OF THE DRAWINGS

The accompanying appendices and/or drawings illustrate various non-limiting, example, inventive aspects in accordance with the present disclosure:

FIG. 1 illustrates a system overview of a computer system utilized in the certain illustrated embodiments;

FIG. 2 illustrates a network view of a certain illustrated embodiment;

FIG. 3 depicts an exemplary communication between a source node and a destination node in the illustrated embodiment of FIG. 2; and

FIG. 4 depicts a method applicable to the exemplary communication of FIG. 3.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

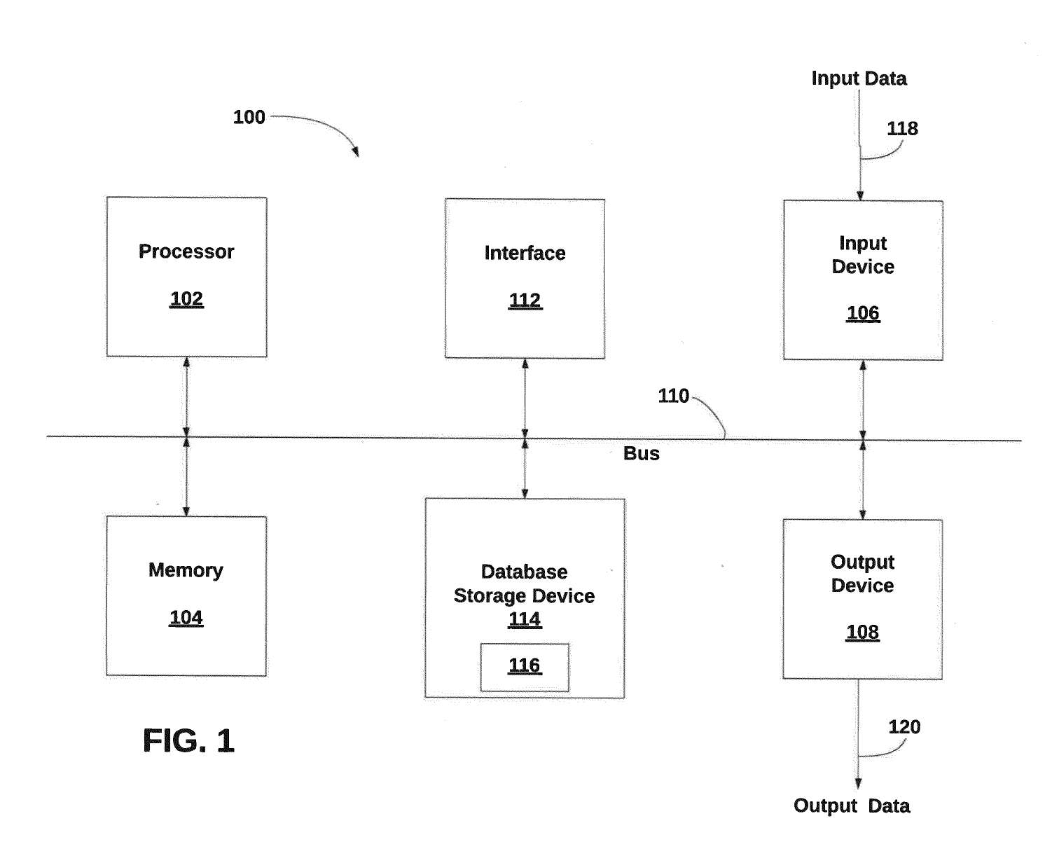

Turning now descriptively to the drawings, in which similar reference characters denote similar elements throughout the several views, FIG. 1 depicts an exemplary general-purpose computing system in which illustrated embodiments of the present invention may be implemented. A generalized computing embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, tablet devices, smart phone devices, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include engines, routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

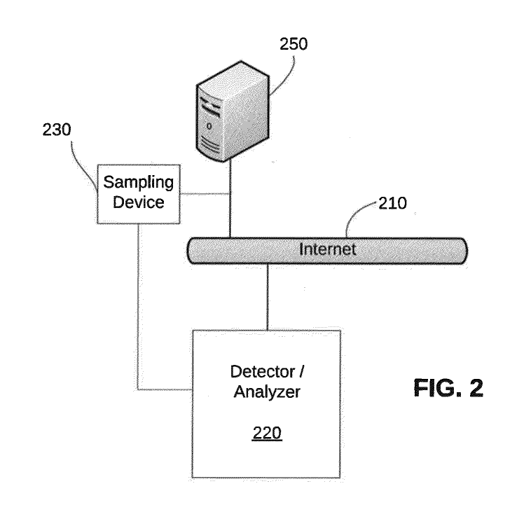

With the exemplary computing system environment 100 of FIG. 1 being generally shown and discussed above, depicted in FIG. 2 is a generalized diagram of a system (referenced generally by numeral 200) for performing the below illustrated techniques of the present invention, which may be utilized with system 100, or components thereof. It is to be understood the present invention is not be limited to what is shown in FIG. 2, as it is to be utilized in any system, apparatus and/or device coupled to a network for receiving samples of web traffic to preferably identify, analyze, and/or block malicious traffic.

System 200 generally includes an analyzing apparatus 220 coupled to one or more sampling devices 230 coupled to the Internet 210. It is to be understood and appreciated the analyzing apparatus 220 and each of the one or more sampling devices 230 includes the above described system 100, or components therefore, to perform the below described functionality in accordance with an illustrated embodiment. It is to be further understood and appreciated analyzing apparatus 220 and a sampling device 230 may be separate components (as illustrated) or may be integrated in one single component.

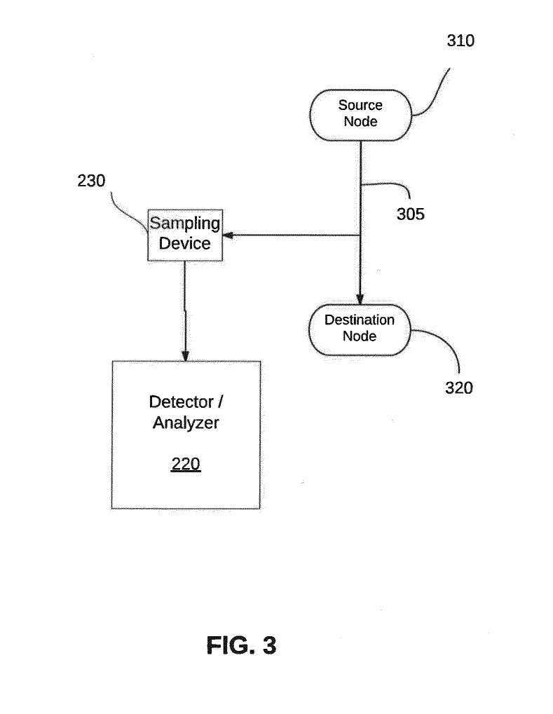

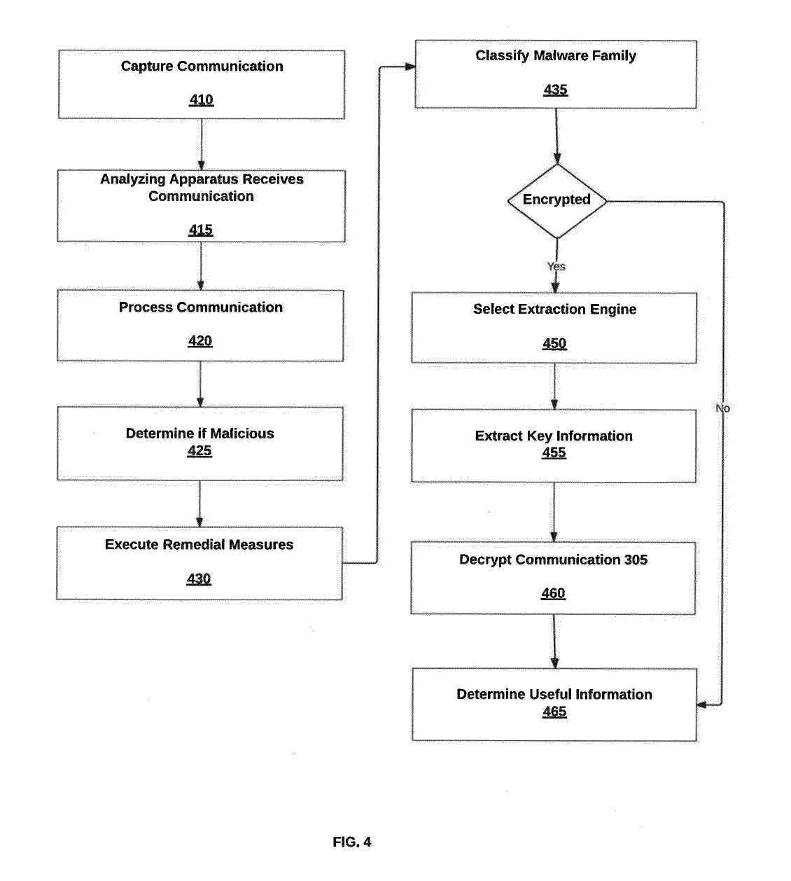

In one example, each sampling device 230 is a device for acquiring malware samples for input into analyzing apparatus 220 for performance of an illustrated embodiment as discussed in conjunction with FIGS. 3 and 4 below. Sampling device 230 may be a network monitoring system, such as an internet sensor, a honeypot, a spam trap, and the like. Further, it is not necessary that the sampling device 230 be directly coupled to analyzing apparatus 220. For instance, the sampling device 230 could reside remotely from analyzing apparatus 220. Further, sampling device 230 does not necessarily need to be in data communication with an analyzing apparatus 220. Samples could be taken at a first location and be manually delivered and input into analyzing apparatus 220, or archived samples could be provided to analyzing apparatus 220. For example, an individual, enterprise, or organization involved in network security (e.g. law enforcement) could collect malware samples and provide them to another entity for input and analysis by analyzing apparatus 220.

Referring to FIG. 3, an exemplary communication 305 between at least one instance of source node 310 and at least one instance of a destination node 320 is shown for illustrative purposes. Communication 305 is intercepted by sampling device 230. A sample of communication 305 is input into analyzing apparatus for illustrative purposes. Source node 310 may be a legitimate source trying to gain access to resources from destination node 320. Alternatively, source node 310 may be malicious. For instance, source node 310 may by a C&C server in control of a botnet and destination node 320 may be an individual bot within a botnet. Alternatively, source node 310 may be an individual bot and destination node 320 may be a C&C server. It is to be further understood and appreciated that source node 310 and destination node 320 may be separated into standalone components or integrated into various combinations.

With reference now to FIGS. 3 and 4, implementation of the various exemplary embodiments of the present invention technique for identifying and analyzing malicious botnet traffic is shown for illustrative purposes. It is noted that the order of steps shown in FIG. 4 is not required, so in principle, the various steps may be performed out of the illustrated order. Also certain steps may be skipped, different steps may be added or substituted, or selected steps or groups of steps may be performed in a separate application following the embodiments described herein.

Starting at step 410, the preferably one or more internet sampling devices 230 capture a sample of communication 305 between source node 310 and destination node 320. In one example, communication 305 may be a legitimate data transmission. In another example, communication 305 may be a suspicious or malicious data transmission, such as an unknown program or an unknown segment of code. In one example, communication 305 may be part of a communication exchange between a bot and a C&C Server. For instance, communication 305 may be a message from a C&C server instructing the bot to take a particular action or a message from a bot providing information to a C&C Server, such as a “phone home” message informing the C&C server of the bot's location (e.g. the IP address of the bot). In one example, the communication may be encrypted.

In step 415, the sample of communication 305 is received by analyzing apparatus 220. As noted, samples of data communications may be sent either directly or indirectly to analyzing apparatus 220 by sampling device 230 or provided by another network monitoring system or entity.

In step 420, analyzing apparatus 220 processes the sample to determine certain information. For instance, analyzing apparatus may determine the source IP address of communication 305 and/or try to determine the content of communication 305. Such information can be useful to determine whether or not communication 305 is a legitimate communication or malicious. In one example, the sample may comprise suspicious code and/or an unknown program and analyzing apparatus 220 would process the sample by creating a sandbox that would execute the code in a controlled environment. The behavior of the code or program could then be used to ascertain certain information about the sample. For instance, if certain code were to exhibit known characteristics of malware (e.g. phoning home to a C&C server), then the code could be classified as malicious malware.

In step 425, the information determined in step 420 is analyzed to determine whether or not communication 305 is malicious (or conversely legitimate). There are a number of techniques that can be utilized either alone or in combination to detect malicious communications, such as malware. Such techniques include both static and dynamic analysis. Furthermore, system 200 may use both network and/or host based indicators to detect malware. The following examples are provided for exemplary purposes only and should not be viewed as limiting the disclosure.

In one example, such analysis may involve utilization of one or more host based and/or network based heuristic techniques to identify a communication as being malicious (or conversely legitimate). For instance, traffic originating from known legitimate web crawlers and bots may be viewed as legitimate whereas traffic originating from known malicious botnets may be viewed as malicious. The originating IP address of communication 305 may be compared to logs contained in memory 104 or elsewhere of known legitimate web crawler or botnet IP addresses. Also, the IP address may be compared to information about known sources of malicious botnet communications. Such information may be openly available (e.g. databases found on the Internet 210), available through subscription, and/or derived from previous samples collected by sampling device 230 and analyzed by analyzing apparatus 220 in accordance with the embodiments described herein. Examples of other heuristic techniques that may be employed to determine whether or not communication 305 is malicious (or conversely legitimate) may be found in U.S. patent application Ser. No. 13/872,824, which is hereby incorporated by reference in its entirety.

If communication 305 is determined to be malicious, then in step 430, remedial measures may be taken to prevent further malicious communications from source node 310 from reaching destination node 320. For example, communications may be blocked. If the sample of communication 305 is not determined to be malicious, then no action may be taken.

In step 435, assuming a determination was made in step 425 that the sample is malicious, then a malware family associated with the sample is identified and the sample is classified as belonging to such malware family. Such a determination may be made by reviewing the sample to determine whether it exhibits certain behavior and/or contains certain information (e.g. bot signatures) that is known about a certain family of botnets, or host-based indicators, or static analysis. Such information may be openly available (e.g. databases found on the Internet 210), available through subscription, and/or derived from previous samples collected by sampling device 230 and analyzed by analyzing apparatus 220 in accordance with the embodiments described herein.

As is the case with malware detection, there are a number of techniques that can be utilized either alone or in combination to classify malware. Such techniques include both static and dynamic analysis. Furthermore, system 200 may use both network and/or host based indicators to classify malware. The preceding examples were provided for exemplary purposes only and should not be viewed as limiting the disclosure.

In step 440, a determination is made by analyzing apparatus 220 as to whether the sample is encrypted. In one example, this determination is as simple as performing the malware classification in step 435. For example, if the sample has been classified as belonging to known malware family X and malware family X is known for using encryption, then system 200 will know that the communication is encrypted.

If the sample is not encrypted, then it is analyzed in step 465 to determine certain useful information, such as the C&C server, the target, and motives of the entity behind the botnet, which can be used to enhance security of the Internet 210. The content of sample and/or any such useful information may be stored in a relational database indexing the sample to other useful information (e.g. time stamp, malware family, originating IP address, destination IP address, C&C server, malware family, the port, the URL of the source 310 and/or destination node 320, etc.)

In step 450, assuming the malware family identified in step 435 uses encryption, an appropriate extraction engine is selected to extract key information from the sample. An extraction engine in one example is program code that when executed by a processor can analyze a malware sample binary and extracted any and all embedded encryption keys which can be used to encrypt and/or decrypt communications. For instance, if the sample is identified as a DarkComet bot, then an extraction engine is selected that is tailored to rip or extract cryptographic keys from the DarkComet family of bots. If the sample is identified as a DeerHunter bot, then an extraction engine is selected that is tailored to rip or extract cryptographic keys from the DeerHunter family of bots.

In step 455, key information is extracted from the sample. By way of example, various botnets are known to utilize certain encryption algorithms. The extraction engine utilizes its knowledge of the encryption algorithm utilized by botnets to extract the keys. The extraction engine analyzes the binary file malware sample until it identifies one or more encryption keys that are utilized by the sample. In some instances, this involves an iterative process due to there being multiple layers of encryption to encrypt the keys themselves. For instance, an encryption key may be used to encrypt another encryption key that is used to encrypt bot communications. It should be understood that the preceding references to DarkComet and DeerHunter are provided for exemplary purposes only and not meant to limit the scope of the present disclosure to these malware families.

In one example, the extracted cryptographic key(s) are stored (e.g. in a relational database) as corresponding to the sample. In another example, the cryptographic keys may be stored in a relational database as corresponding to an identifier (e.g. URL, IP address) of source node 310 (i.e. the C&C server that was involved in the communication exchange containing the communication) and/or destination node 320. Accordingly, future encrypted communications involving source node 310 and/or destination node 320 may be decrypted through utilization of the cryptographic key(s) associated with the C&C server.

In step 460, the cryptographic keys may be utilized to decrypt communication 305. Then flow passes step 465 in which the sample is analyzed to determine certain useful information, such as the C&C server, the target, and motives of the entity behind the botnet, which can be used to enhance security of the Internet 210. The content of communication 305 and/or any such useful information may be stored in a relational database indexing communication 305 to other useful information (e.g. time stamp, malware family, originating IP address, destination IP address, C&C server, malware family, the port, the URL of the source 310 and/or destination node 320, etc.)

In addition, the extracted encryption keys may be used to generate encrypted communications that are sent to the malware sample's C&C server, impersonating a real bot, and then to decrypt any and all responses from this C&C server in order to extract commands. This type of monitoring of C&C commands may be performed indefinitely. The results of such monitoring can then be stored in a database or other archive to assist law enforcement or other parties involved in combating malware to defend and mitigate against future attacks.

With the certain illustrated embodiments described above, it is to be understood optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the illustrated embodiments and of the manner and process of making and using them in such full, clear, concise, and exact terms as to enable any person skilled in the art to which it pertains to make and use these devices and methods. The illustrated embodiments are, however, susceptible to modifications and alternative method steps from those discussed above that are fully equivalent. Consequently, the above described illustrated embodiments are not limited to the particular embodiments disclosed. On the contrary, they may encompass all modifications and alternative constructions and methods coming within the spirit and scope of the invention.

What is claimed is:

1. A method performed by a computer system having one or more processors and memory storing one or more programs for execution by the one or more processors, comprising:
receiving a sample of a first data transmission over a network;
classifying the sample as belonging to a malware family;
selecting an extraction engine corresponding to the malware family; and
utilizing the extraction engine to extract cryptographic data from the sample.

2. A method as recited in claim 1 further including the step of storing the cryptographic data in a relational database.

3. A method as recited in claim 2 further including the steps of:
receiving a sample of a second data transmission over the network; and
utilizing stored cryptographic data in the relational database to decode the sample of the second data transmission.

4. A method as recited in claim 2 wherein the step of storing comprises associating the cryptographic data with a server that sent the first data transmission.

5. A method as recited in claim 1 wherein the step of classifying comprises determining that the first data transmission is a communication exchange between a bot and a command and control server belonging to a botnet family.

6. The method of claim 5 further comprising the step of determining that the sample is encrypted.

7. A method as recited in claim 6 further comprising the step of identifying an encryption algorithm utilized to encrypt the sample.

8. A method as recited in claim 6 further comprising the step of identifying at least one cryptographic key utilized to encrypt the sample.

9. A method as recited in claim 8 further comprising associating the at least one cryptographic key with the command and control server in a relational database.

10. A method as recited in claim 9 further comprising the step of using the cryptographic key to decrypt at least one other sample of one other data transmission originating from the command and control server.

11. A system for extracting cryptographic data from a data transmission, comprising:
a memory;
a processor disposed in communication with said memory, and configured to issue a plurality of instructions stored in the memory, wherein the instructions issue signals to:
receive a sample of a first data transmission over a network;
classify the sample as belonging to a malware family;
select an extraction engine corresponding to the malware family; and
utilizing the extraction engine to extract cryptographic data from the sample.

12. A system as recited in claim 11 wherein the processor is further configured to store the cryptographic data in a relational database.

13. A system as recited in claim 12 wherein the processor is further configured to:
receive a sample of a second data transmission over the network; and
utilize stored cryptographic data in the relational database to decode the sample of the second data transmission.

14. A system as recited in claim 12 wherein the processor is further configured to associate the cryptographic data with a server that sent the first data transmission.

15. A system as recited in claim 11 wherein the processor is further configured to determine that the first data transmission is a communication exchange between a bot and a command and control server belonging to a botnet family

16. A system as recited in claim 15 wherein the processor is further configured to determine that the sample is encrypted.

17. A system as recited in claim 16 wherein the processor is further configured to identify an encryption algorithm utilized to encrypt the sample.

18. A system as recited in claim 16 wherein the processor is further configured to identify at least one cryptographic key utilized to encrypt the sample.

19. A system as recited in claim 18 wherein the processor is further configured to associate the at least one cryptographic key with the command and control server in a relational database.

20. A system as recited in claim 19 wherein the processor is further configured to use the cryptographic key to decrypt at least one other sample from one other data transmission originating from the command and control server.
